(19) United States
(12) Patent Application Publication
(10) Pub. No.: US 2024/0242143 A1
(43) Pub. Date: Jul. 18, 2024

(54) COMPUTERIZED-METHOD AND COMPUTERIZED-SYSTEM FOR IDENTIFYING HIGH IMPACTED SCHEDULES, IN A CONTACT CENTER

(71) Applicant: NICE LTD., Ra'anana (IL)

(72) Inventors: Harshad AMBEKAR, Pune (IN); Salil DHAWAN, Pune (IN); Swati KADU, Pune (IN)

(21) Appl. No.: 18/097,324

(22) Filed: Jan. 16, 2023

(51) Int. Cl. G06Q 10/0631; G06Q 10/0639; H04M 3/51

(52) U.S. Cl. CPC G06Q 10/063116; G06Q 10/06398; H04M 3/5175; H04M 2203/402

(57) ABSTRACT

A computerized-method for identifying high impacted schedules, in a contact center is provided herein. The computerized-method includes retrieving schedules of agents during a preconfigured period from a Workforce Management (WFM) system. For each schedule: (i) operating a schedule quotient module to derive schedule-quotient score; (ii) operating an agent quotient module to derive agent-quotient score; (iii) operating a Schedule Impact Score (SIS) module to derive a schedule-impact score based on the derived schedule-quotient score and the derived agent-quotient score; and (iv) operating a recommendation module for auto-corrective measures in one or more systems based on the derived schedule-impact score.

### TECHNICAL FIELD

The present disclosure relates to the field of data analysis and more specifically to identifying high impacted schedules, in a contact center.

### BACKGROUND

Workforce Management (WFM) scheduling is a platform in contact centers which enables to determine how many employees are required for a specific task at any given time. The complexity of the process when using the platform may depend on the amount and the diversity of the workforce.

A WFM schedule may be generated for each agent in the contact center. The agents may work part-time or full-time and may be based in different locations including different countries. Under certain circumstances, the agents may not be able to attend a schedule or may send a request for time-off or a request for trade-off for the schedule. These circumstances may cause staffing issues, such as imbalances of staffing within different workgroups of the call center, especially when the call center manages thousands of call center agents.

Therefore, schedule adherence plays an underlying role in contact center performance, and it helps companies understand how to better optimize resources. Low adherence rates may result in poor customer service. Nonadherence to schedule, understaffing, and poor agent performance are one of the challenges faced today in WFM systems and it has a detrimental impact on contact center performance which deteriorates customer experience.

The effort of contact center, which is invested into forecasting, the process of estimating future contact volume and into scheduling may be wasted when agents don't adhere to their schedules. Currently, there is no mechanism in place that can provide the impact of agent schedule nonadherence, agent performance, traffic volume trend indicators, pandemic and natural calamity indicators, as well as various other contact center parameters that may impact a schedule.

When the impact of parameters on a schedule in contact center is not known, then effective planning or measures may not be operated in advance for such impacted schedules which may result in lower customer satisfaction and increased workload for performant agents. An impacted schedule may also be an indicator of impacted agent productivity and impacted contact center productivity, which may negatively affect customer experience.

Hence, there is a need for a technical solution to find the impact on each schedule in a contact center so that effective WFM and impact mitigation may be operated. There is a need for a system and method for identifying high impacted schedules, in a contact center, such that the contact center may act upon it for remediation and fixing of underlying issues.

### SUMMARY

There is thus provided, in accordance with some embodiments of the present disclosure, a computerized-method for identifying high impacted schedules, in a contact center.

Furthermore, in accordance with some embodiments of the present disclosure, the computerized-method may include retrieving schedules of agents during a preconfigured period from a Workforce Management (WFM) system.

Furthermore, in accordance with some embodiments of the present disclosure, for each schedule the computerized-method may: (i) operate a schedule quotient module to derive schedule-quotient score; (ii) operate an agent quotient module to derive agent-quotient score; (iii) operate a Schedule Impact Score (SIS) module to derive a schedule-impact score based on the derived schedule-quotient score and the derived agent-quotient score; and (iv) operate a recommendation module for auto-corrective measures in one or more systems based on the derived schedule-impact score.

Furthermore, in accordance with some embodiments of the present disclosure, the retrieved schedules may be at least one of: (i) active schedules and the schedule-impact score is derived in real-time; and (ii) future schedules.

Furthermore, in accordance with some embodiments of the present disclosure, the auto-corrective measures may include at least one of: (i) displaying the derived schedule-impact score of each schedule on schedule management dashboard which is associated to a schedule management module in the WFM system; (ii) generating a report including key statistics representing an impact of the schedule on schedule working days; (iii) performing realignment of routing of an Automatic Call Distribution (ACD) system; (iv) optimizing schedules in the WFM system in an order that is based on each schedule schedule-impact score.

Furthermore, in accordance with some embodiments of the present disclosure, the schedule quotient module may derive the schedule-quotient score based on retrieved schedule metrics from a schedule metrics database.

Furthermore, in accordance with some embodiments of the present disclosure, the agent-quotient score may be derived based on retrieved agent metrics from an agent metrics database.

Furthermore, in accordance with some embodiments of the present disclosure, the schedule quotient module may derive the schedule-quotient score based on at least one parameter of: (i) schedule staffing variance; (ii) Schedule average Service Level Agreement (SLA) variance in a preconfigured period; (iii) Average Handle Time (AHT) for this schedule in the preconfigured period; (iv) Average Speed of Answer (ASA) for the schedule in the preconfigured period; (v) number of time-off requests raised for the schedule in status of approved, pending and denied; (vi) number of shift trade-off requests raised for the schedule in status of approved, pending and denied; (vii) forecast results of whether the schedule could be impacted due to natural calamities or pandemic situations; (viii) forecast results for trend change in call or interactions volume for this schedule; (ix) average customer sentiment for interactions handled in the schedule in the preconfigured period; (x) number of schedule changes in status of approved, pending and denied; and (xi) percentage of agents having a user-defined activity code which prevents them from contributing to participate in activities of the schedule.

Furthermore, in accordance with some embodiments of the present disclosure, the agent quotient module may derive the agent-quotient score based on at least one parameter of: (i) average schedule adherence; (ii) average agent performance; (iii) average agent proficiency; (iv) average agent sentiments for interactions handled in the schedule in a preconfigured period; (v) average agent occupancy rate in the schedule in the preconfigured period; (vi) agent absenteeism trend in the preconfigured period; (vii) agent performing overtime; (viii) agent tenure; (ix) agent with more than a preconfigured number of skills; (x) percentage of agents with assigned skills in less than preconfigured number of days; (xi) percentage of agents having handling concurrent interactions in a preconfigured number of skills; (xii) percentage of agents working shifts more than a preconfigured number of hours; (xiii) percentage of agents whose last day off was a preconfigured number of days prior to the schedule; (xiv) agents schedule preferences; (xv) agent handling more than a preconfigured number of concurrent interactions; (xvi) percentage of agents not associated to a preconfigured business unit; and (xvii) total time planned for a user-defined activity code where the agent would not contribute to the schedule with the agent's skills.

Furthermore, in accordance with some embodiments of the present disclosure, the optimizing of schedules in a Workforce Management (WFM) system in an order that is based on each schedule schedule-impact score may include optimizing schedules for resource overstaffing and optimizing for schedules for resource understaffing.

Furthermore, in accordance with some embodiments of the present disclosure, the derived schedule-impact score may be further used for performance rewards and recognition of highly performant agents in schedules having a schedule-impact score above a preconfigured threshold.

Furthermore, in accordance with some embodiments of the present disclosure, the schedule-impact score may be further used by a Quality Management (QM) system by: (i) checking a schedule-impact score above a preconfigured threshold for an increased sampling rate of interactions during the schedule-impact score related schedule; (ii) upon evaluation, assigning agents, in interactions lacking quality metrics in the related schedule, to training.

Furthermore, in accordance with some embodiments of the present disclosure, the SIS module derives the schedule-impact score base on formula I:

Schedule Impact Score=Σ(schedule-quotient score×W₁+agent-quotient score×W₂) (I)
whereby:
schedule-quotient score is the derived schedule-quotient score,
agent-quotient score is the derived agent-quotient score,
W₁ is a first preconfigured weightage, and
W₂ is a second preconfigured weightage,
wherein a value of W₁ and a value of W₂ ranges between ‘0’ and ‘1’.

There is further provided, in accordance with some embodiments of the present invention, a computerized-system for identifying high impacted schedules, in a contact center.

Furthermore, in accordance with some embodiments of the present disclosure, the computerized-system may include: one or more processors; database of agent metrics; database of schedule metrics; a memory to store the database of agents metrics and the database of schedule metrics.

Furthermore, in accordance with some embodiments of the present disclosure, the one or more processors may be configured to retrieve schedules during a preconfigured period from a WFM system, for each schedule: (i) operate a schedule quotient module to derive schedule-quotient score; (ii) operate an agent quotient module to derive agent-quotient score; (iii) operate a Schedule Impact Score (SIS) module to derive a schedule-impact score based on the derived schedule-quotient score and the derived agent-quotient score; and (iv) operate a recommendation module for auto-corrective measures in one or more systems based on the derived schedule-impact score.

### BRIEF DESCRIPTION OF THE DRAWINGS

In order for the present invention, to be better understood and for its practical applications to be appreciated, the following Figures are provided and referenced hereafter. It should be noted that the Figures are given as examples only and in no way limit the scope of the invention. Like components are denoted by like reference numerals.

FIGS. 1A-1B schematically illustrate a high-level diagram of a computerized-system for identifying high impacted schedules, in a contact center, in accordance with some embodiments of the present invention;

FIG. 2 is a schematic flowchart of an operation of identifying high impacted schedules, in a contact center, in accordance with some embodiments of the present invention;

FIG. 3 is an example of schedule impact presented on supervisor dashboard, based on Schedule Impact Score (SIS), in accordance with some embodiments of the present invention;

FIGS. 4A-4B are schematic flowcharts of optimizing schedules for resource overstaffing and understaffing, in accordance with some embodiments of the present invention;

FIG. 5 is a schematic flowchart of getting the agents from WFM for scheduling, in accordance with some embodiments of the present invention;

FIG. 6 is a schematic flowchart of performance rewards and recognition for highly performant agents in highly impacted schedule, in accordance with some embodiments of the present invention;

FIG. 7 is a schematic flowchart of schedule-impact score usage by a Quality Management (QM) system, in accordance with some embodiments of the present invention;

FIG. 8 is an example of a recommendation engine and assignment of automated actions, in accordance with some embodiments of the present invention;

FIG. 9 is an example of a monthly view of a schedule which displays the days on which the schedule is impacted, in accordance with some embodiments of the present invention;

FIG. 10 is an example of the schedule in weekly view, which can help planning for a week, in accordance with some embodiments of the present invention;

FIGS. 11A-11B show an example of the impacted parameters in a schedule, in accordance with some embodiments of the present invention; and

FIG. 12 shows an example for a report including key statistics representing an impact of the schedule on schedule working days, in accordance with some embodiments of the present invention

### DETAILED DESCRIPTION

In the following detailed description, numerous specific details are set forth in order to provide a thorough understanding of the disclosure. However, it will be understood by those of ordinary skill in the art that the disclosure may be practiced without these specific details. In other instances, well-known methods, procedures, components, modules, units and/or circuits have not been described in detail so as not to obscure the disclosure.

Although embodiments of the disclosure are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium (e.g., a memory) that may store instructions to perform operations and/or processes.

Although embodiments of the disclosure are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed simultaneously, at the same point in time, or concurrently. Unless otherwise indicated, use of the conjunction “or” as used herein is to be understood as inclusive (any or all of the stated options).

The term “high impacted schedule” as used herein refers to a schedule that is negatively affected by one or more parameters, such as rate of agent schedule nonadherence, agent performance, traffic volume trend indicators, pandemic, and natural calamity indicators.

Therefore, there is a need for a system and method for identifying high impacted schedules, in a contact center.

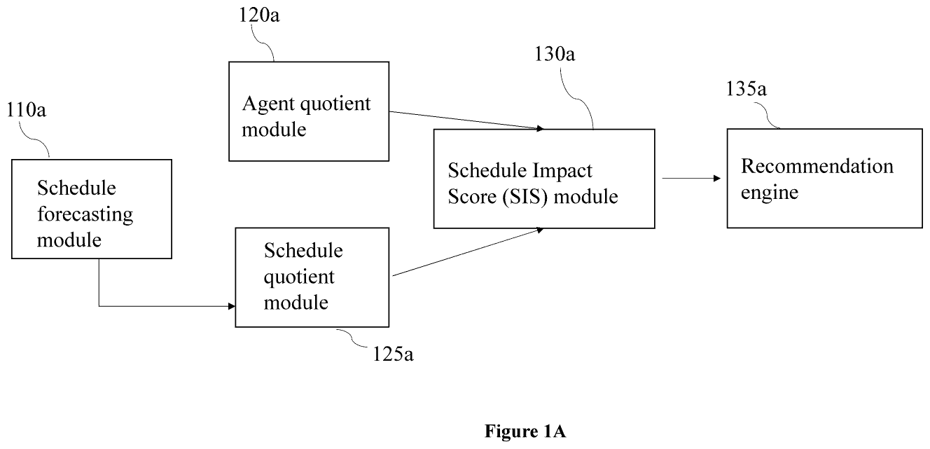

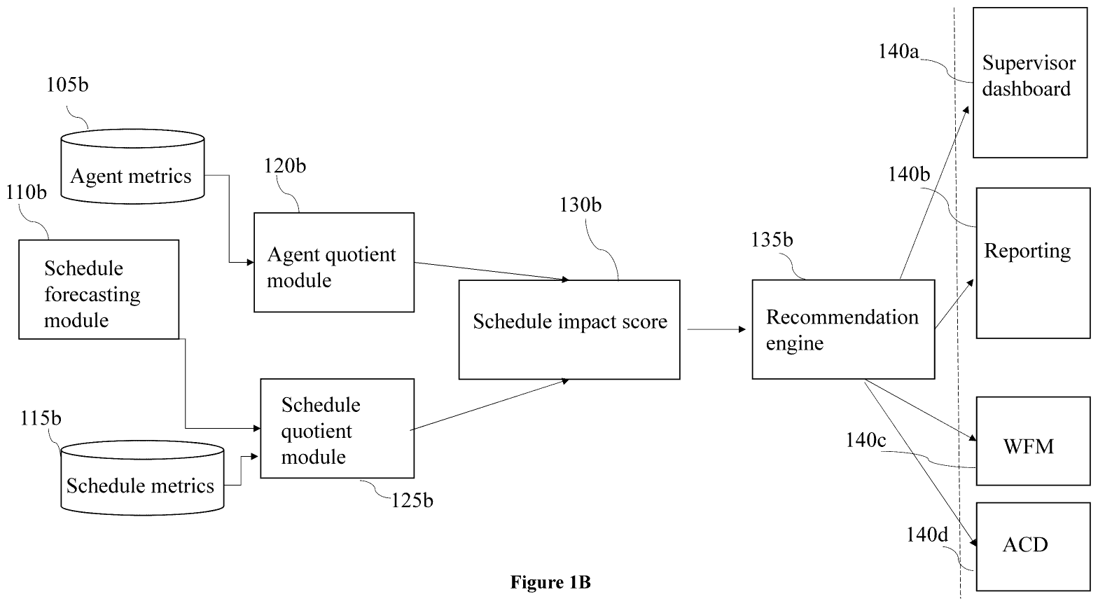

FIG. 1A schematically illustrates a high-level diagram of a computerized-system 100A for identifying high impacted schedules, in a contact center, in accordance with some embodiments of the present invention.

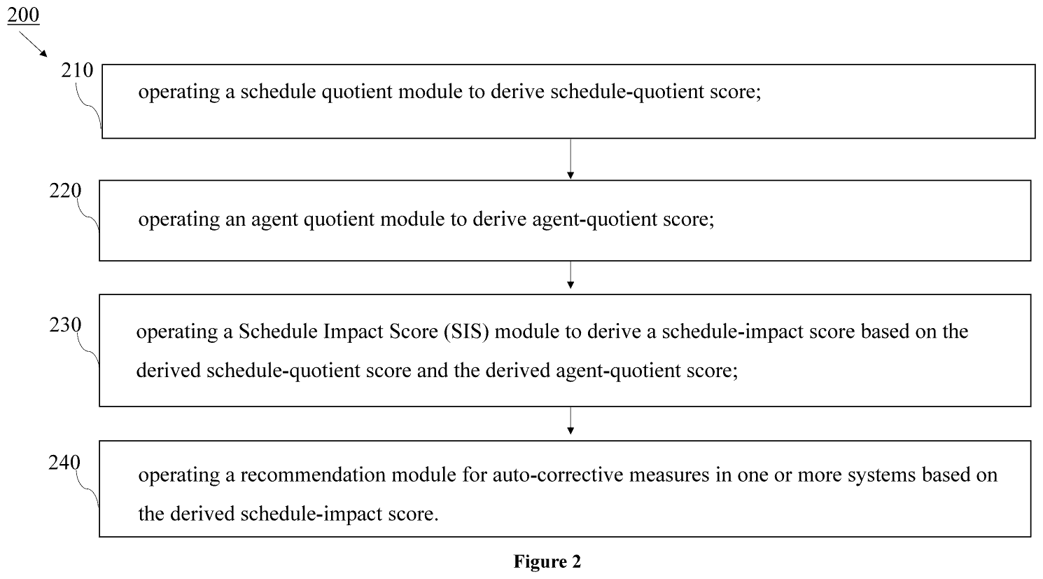

According to some embodiments of the present disclosure, in a system, such as computerized-system 100A for identifying high impacted schedules, in a contact center, by operation of identifying high impacted schedules, in a contact center, such as operation 200 in FIG. 2, one or more processors (not shown) may be configured to retrieve schedules during a preconfigured period from a module, such as schedule forecasting module 110a in a Workforce Management (WFM) system (not shown) and for each schedule operating a module, such as schedule quotient module 125a to derive schedule-quotient score.

According to some embodiments of the present disclosure, the schedule quotient module 125a may derive the schedule-quotient score based on at least one parameter of: (i) schedule staffing variance; (ii) Schedule average Service Level Agreement (SLA) variance in a preconfigured period; (iii) Average Handle Time (AHT) for this schedule in the preconfigured period; (iv) Average Speed of Answer (ASA) for the schedule in the preconfigured period; (v) number of time-off requests raised for the schedule in status of approved, pending and denied; (vi) number of shift trade-off requests raised for the schedule in status of approved, pending and denied; (vii) forecast results of whether the schedule could be impacted due to natural calamities or pandemic situations; (viii) forecast results for trend change in call or interactions volume for this schedule; (ix) average customer sentiment for interactions handled in the schedule in the preconfigured period; (x) number of schedule changes in status of approved, pending and denied; and (xi) percentage of agents having a user-defined activity code which prevents them from contributing to participate in activities of the schedule.

According to some embodiments of the present disclosure, for example, a weighted score of a schedule related parameter may be calculated as follows:

| | | | Sample Rating | | | | |
|---|---|---|---|---|---|---|---|
| | | | Determination | Sample | | | |
| | | Param- | based on | Param- | | | Score |
| Parameter | Parameter | eter | Parameter | eter | Sample | | (Rating × |
| Name | Description | Type | Value | Value | Rating | Weight | weight) |
| scheduleStaffingVari- | Schedule Staffing Variance | Schedule | If Schedule Variance | −8 | 100 | 1 | 100 |
| anceUnderStaffing | less than threshold | Quotient | is less than −5 | | | | |
| | (Understaffing) | | Rating is 100 | | | | |
| | scheduleStaffing | | If Schedule Variance | | | | |
| | VarianceUnderStaffing = | | is less than −2 | | | | |
| | (Required count of agents | | and greater than −5 | | | | |
| | as per forecasting − | | Rating is 50 | | | | |
| | Available count of agents) | | | | | | |
| scheduleStaffingVari- | Schedule Staffing Variance | Schedule | If Schedule Variance | 11 | 100 | 1 | 100 |
| anceOverStaffing | is more than threshold | Quotient | is greater than 10 | | | | |
| | (Overstaffing) | | than rating is 100 | | | | |
| | scheduleStaffing | | If Schedule Variance | | | | |
| | VarianceOverStaffing = | | is less than 10 but | | | | |
| | (Available count of | | greater than 5 than | | | | |
| | agents − Required count | | Rating is 20 | | | | |
| | of agents as per | | If Schedule Variance | | | | |
| | forecasting ) | | is less than 5 but | | | | |
| | | | greater than 2 than | | | | |
| | | | Rating is 10 else 0 | | | | |
| average- | Schedule Average SLA | Schedule | If average SLA | 11% | 50 | 1 | 50 |
| SLAVariance | variance | Quotient | variance for the | | | | |
| | averageSLAVariance = | | given weekday/ | | | | |
| | Average of SLA variance | | all days was more | | | | |
| | for the schedule in a | | than 10% then rating | | | | |
| | given period in past. | | is 50 else if average | | | | |
| | E.g., if SLA was to | | SLA variance was more | | | | |
| | answer 80% calls in | | than 5% but less than | | | | |
| | 30 sec but on an average | | 10% than rating is 20 | | | | |
| | agents could answer on | | else 0 | | | | |
| | 50% calls in 30 sec the | | | | | | |
| | variance is 30% for the | | | | | | |
| | schedule | | | | | | |
| aver- | Schedule Average ASA | Schedule | If averageSpeedOf | 11% | 50 | 1 | 50 |
| ageSpeedOfAn- | (Average Speed of | Quotient | Answer is deterioting | | | | |
| swer | Answer) averageSpeedOf | | by 10% or above then | | | | |
| | Answer = Average | | rating is 50 average | | | | |
| | Speed of answer for the | | ASA is deterioting | | | | |
| | schedule in past for a | | between 5% to 10% or | | | | |
| | given period | | above then rating is | | | | |
| | If averageSpeedOf Answer | | 20 else 0 | | | | |
| | is deterioting by x% or | | | | | | |
| | above then schedule is | | | | | | |
| | impacted | | | | | | |
| averageHan- | Schedule Average AHT | Schedule | If average AHT | 11% | 50 | 1 | 50 |
| dlingTime | (Average Handling | Quotient | is deterioting by | | | | |
| | Time) averageHan- | | 10% or above then | | | | |
| | dlingTime Average | | rating is 50 average | | | | |
| | Handling time for the | | AHT is deterioting | | | | |
| | schedule in past for a | | between 5% to 10% or | | | | |
| | given period | | above then rating is | | | | |
| | If averageHandlingTime | | 20 else 0 | | | | |
| | is deteriorating by | | | | | | |
| | x% or above then schedule | | | | | | |
| | is impacted | | | | | | |
| timeOffRe- | Count of timeoff request | Schedule | If count of timeoff | Under- | 100 | 1 | 100 |
| questsPending | pending to be approved/ | Quotient | request raised for the | staffed | | | |
| | rejected for the schedule | | schedule when | | | | |
| | (Pending request count) | | understaffed then rating | | | | |
| | If timeOffRequests | | is 100 else if count of | | | | |
| | Pending is more than 1 | | timeoff request raised | | | | |
| | when understaffed then it | | if approved will lead to | | | | |
| | will impact the schedule | | understaffing than rating | | | | |
| | If timeOffRequests | | is 80 else 0 | | | | |
| | Pending when approved | | | | | | |
| | will lead to understaffing | | | | | | |
| | as per schedule staffing | | | | | | |
| | predictions then schedule | | | | | | |
| | will be impacted | | | | | | |
| timeOffRe- | Count of timeoff request | Schedule | If timeOffRe- | 10 | 50 | 1 | 50 |
| questsApproved | approved for the schedule. | Quotient | questsApproved is above | | | | |
| | If timeOffRequests | | x then rating is 50 else | | | | |
| | Approved for the schedule | | 0 E.g., x is 5 | | | | |
| | is above a threshold it | | | | | | |
| | means agents are probably | | | | | | |
| | not happy with this schedule | | | | | | |
| | and chances are that many | | | | | | |
| | more agents may remain | | | | | | |
| | absent. If approved time- | | | | | | |
| | off requests above X then | | | | | | |
| | schedule is impacted | | | | | | |
| timeOffRe- | Count of timeoff request | Schedule | If timeOffRe- | 5 | 80 | 1 | 80 |
| questsDenied | denied for the schedule. | Quotient | questsDenied is above | | | | |
| | If timeOffRequests | | x then rating is 50 | | | | |
| | Denied for the schedule | | else 0 E.g., x is 5 | | | | |
| | is above a threshold it | | | | | | |
| | means agents are probably | | | | | | |
| | not happy with this schedule | | | | | | |
| | and chances are that many | | | | | | |
| | more agents may remain | | | | | | |
| | absent. | | | | | | |
| | This parameter is probable | | | | | | |
| | understaffing indicator. | | | | | | |
| shiftTradeRe- | Count of shift trade | Schedule | If shiftTradeRe- | 10 | 50 | 1 | 50 |
| questsPending | pending to be approved or | Quotient | questsPending are above | | | | |
| | rejected for the schedule | | a threshold (e.g., 5) | | | | |
| | (Pending Shift Trade | | then rating is 50 else 0 | | | | |
| | requests). | | | | | | |
| | More pending shift trade | | | | | | |
| | requests means exisiting | | | | | | |
| | agents are not happy with | | | | | | |
| | the schedule and need to | | | | | | |
| | swap. | | | | | | |
| | If shiftTradeRe- | | | | | | |
| | questsPending is above a | | | | | | |
| | threshold then schedule | | | | | | |
| | could get impacted | | | | | | |
| shitTradeRe- | Count of shift trade | Schedule | If shitTradeRe- | 6 | −50 | 1 | −50 |
| questsApproved | request approved for the | Quotient | questsApproved is | | | | |
| | schedule. More approved | | greater than threshold | | | | |
| | shift trade requests indicate | | then rating is −50 | | | | |
| | that agents prefer this shift. | | indicating that schedule | | | | |
| | So less impact on schedule. | | has less impact e.g., If | | | | |
| | If shitTradeRequestsApproved | | threshold is 5 then if | | | | |
| | is above a threshold it's | | shiftTradeRequestApproved | | | | |
| | an indicator of less | | are 6 and above then | | | | |
| | schedule impact | | rating is −50 | | | | |
| shiftTradeRe- | Count of shift trade | Schedule | IfshiftTradeRequestsDenied | 6 | 50 | 1 | 50 |
| questsDenied | request denied cancelled | Quotient | is greater than threshold | | | | |
| | for the schedule. Too | | then rating is 50 else 0 | | | | |
| | many cancelled shift | | Threshold is 5 | | | | |
| | trade requests can lead | | | | | | |
| | to dissatisfied agents | | | | | | |
| | work in the shift and | | | | | | |
| | could impact the agent | | | | | | |
| | performance and could also | | | | | | |
| | lead to agent absenteeism. | | | | | | |
| | These factors would impact | | | | | | |
| | the schedule. | | | | | | |
| sched- | Count of Schedule | Schedule | If | 11 | 50 | 1 | 50 |
| uleChangesPend- | Changes Pending. If | Quotient | scheduleChangesPending | | | | |
| ing | too many schedule changes | | is greater than | | | | |
| | are pending to be | | threshold then rating | | | | |
| | approved, the schedule | | is 50 else 0 | | | | |
| | could get impact when | | Threshold = 10 | | | | |
| | these changes | | | | | | |
| | get approved. | | | | | | |
| sched- | Count of Schedule | Schedule | If | 10 | 50 | 1 | 50 |
| uleChangesAp- | Changes approved (an | Quotient | scheduleChangesApproved | | | | |
| proved | indicator that the | | is greater than | | | | |
| | original schedule has | | threshold then rating | | | | |
| | been frequently modified, | | is 50 else 0 | | | | |
| | which may lead to | | Threshold is 9 | | | | |
| | adherence issues, | | | | | | |
| | coverage issues, etc.). | | | | | | |
| | If too many schedule | | | | | | |
| | changes approved, the | | | | | | |
| | schedule could get | | | | | | |
| | impacted. | | | | | | |
| sched- | Count of Schedule | Schedule | If | 10 | 50 | 1 | 50 |
| uleChangedDe- | Changes Denied (an | Quotient | scheduleChangedDenied | | | | |
| nied | indicator of employee | | is greater than | | | | |
| | dissatisfaction that may | | threshold then rating | | | | |
| | translate into poor | | is 50 else 0 | | | | |
| | adherence or absenteeism). | | Threshold is 9 | | | | |
| | If too many schedule | | | | | | |
| | changes are denied it | | | | | | |
| | could lead to agent | | | | | | |
| | dissatisfaction. | | | | | | |
| fore- | Forecasting for schedule | Schedule | If there is forecasting | Yes | 100 | 2 | 200 |
| castedSched- | getting impacted due to | Quotient | where agent availability | | | | |
| uleImpact | natural calamites or | | could drop drastically | | | | |
| | pandemic situation. | | then rating is 100 | | | | |
| | | | If there is forecasting | | | | |
| | | | where only few agents | | | | |
| | | | in some region could get | | | | |
| | | | impacted than rating is | | | | |
| | | | 50 | | | | |
| vol- | Volume trend change | Schedule | Volume change in % e.g., | Schedule | 100 | 2 | 200 |
| umeTrendChangeIn- | indicated. If agent | Quotient | 10% indicates 10% | count not | | | |
| dicator | scheduled are not | | increase. Check if | as per | | | |
| | sufficient to satisfy | | agent scheduled count | trend | | | |
| | the forecasted increased | | is increased as per the | change | | | |
| | volume trend of calls | | trend change. If yes | | | | |
| | then schedule could | | rating is 10 indicating | | | | |
| | get impacted. | | only trend change else | | | | |
| | | | rating is 100. | | | | |
| averageCus- | Average Customer | Schedule | If average customer | Negative | 50 | 1 | 50 |
| tomerSentiments | sentiments for | Quotient | sentiments for this | | | | |
| | the schedule | | schedule has been negative | | | | |
| | | | than rating is 50 if | | | | |
| | | | neutral than rating is | | | | |
| | | | 30 else 0 | | | | |
| agentUnAvail- | If x percentage of | Schedule | If 20% or more number | 25 | 100 | 1 | 100 |
| abilityForSkills | Agents are unavailable | Quotient | of agents have | | | | |
| | for skills as they are | | user-defined activity | | | | |
| | in training, meeting | | code then rating is | | | | |
| | or some other planned | | 100 else 0 | | | | |
| | activities, then | | | | | | |
| | schedule could | | | | | | |
| | get impacted | | | | | | |

According to some embodiments of the present disclosure, the retrieved schedules may be at least one of: (i) active schedules and the schedule-impact score may be derived in real-time; and (ii) future schedules.

According to some embodiments of the present disclosure, a module, such as agent quotient module 120a may be operated to derive agent-quotient score. Based on the derived schedule-quotient score from the schedule quotient module 125a and the derived agent-quotient score from the agent quotient module 120a, a schedule-impact score may be derived by operating a module, such as Schedule Impact Score (SIS) module 130a. The schedule-impact score may indicate a level of impact of schedule nonadherence.

According to some embodiments of the present disclosure, the SIS module 130a may derive the schedule-impact score base on formula I:

Schedule Impact Score=Σ(schedule-quotient score×W₁+agent-quotient score×W₂) (I)
whereby:
schedule-quotient score is the derived schedule-quotient score,
agent-quotient score is the derived agent-quotient score,
W₁ is a first preconfigured weightage,
W₂ is a second preconfigured weightage,
wherein a value of W₁ and a value of W₂ ranges between ‘0’ and ‘1’.

According to some embodiments of the present disclosure, the agent quotient module 125a may derive the agent-quotient score based on at least one parameter of: (i) average schedule adherence; (ii) average agent performance; (iii) average agent proficiency; (iv) average agent sentiments for interactions handled in the schedule in a preconfigured period; (v) average agent occupancy rate in the schedule in the preconfigured period; (vi) agent absenteeism trend in the preconfigured period; (vii) agent performing overtime; (viii) agent tenure; (ix) agent with more than a preconfigured number of skills; (x) percentage of agents with assigned skills in less than preconfigured number of days; (xi) percentage of agents handling concurrent interactions in a preconfigured number of skills; (xii) percentage of agents working shifts more than a preconfigured number of hours; (xiii) percentage of agents whose last day off was a preconfigured number of days prior to the schedule; (xiv) agents schedule preferences; (xv) agent handling more than a preconfigured number of concurrent interactions; (xvi) percentage of agents not associated to a preconfigured business unit; and (xvii) total time planned for a user-defined activity code where the agent would not contribute to the schedule with the agent's skills.

According to some embodiments of the present disclosure, for example, a weighted score of an agent related parameter may be calculated as follows:

| | | | Sample Rating | | | | |
|---|---|---|---|---|---|---|---|
| | | | Determination | | | | |
| | | | based on | Sample | | | Score |
| Parameter | Parameter | Parameter | Parameter | Parameter | Sample | | (Rating × |
| Name | Description | Type | Value | Value | Rating | Weight | weight) |
| averageSched- | Average Schedule Adherance | Agent | If Avg Schedule Adherence | 75% | 50 | 1 | 50 |
| uleAdherance | for Agents participating | Quotient | of Agents marked for | | | | |
| | in the schedule for a | | schedule is less than 95% | | | | |
| | given duration = Σ | | and greater than 85% then | | | | |
| | (Minutes in Adherence/ | | Rating is 30 | | | | |
| | Total Scheduled | | If Avg Schedule Adherence | | | | |
| | Minutes) × 100 | | is less than 85% then | | | | |
| | | | Rating is 50 Schedule | | | | |
| averagePerfor- | Average performance | Agent | Average Performance | 2 | 50 | 2 | 100 |
| manceRating | Rating of the Agents | Quotient | Rating is: 2 and | | | | |
| | in the Schedule | | below then set Rating | | | | |
| | | | here as 50 3 then set | | | | |
| | | | Rating as 20 else 0 | | | | |
| | | | Agent Performance | | | | |
| | | | Scale(5 - Excellent, | | | | |
| | | | 4 - Good, | | | | |
| | | | 3 - Meets Expectation, | | | | |
| | | | 2 - Needs | | | | |
| | | | Improvement, | | | | |
| | | | 1 - Not Satisfactory) | | | | |
| averageAgentSen- | Average Agent | Agent | If average customer | Negative | 50 | 1 | 50 |
| timents | sentiments for | Quotient | sentiments for this | | | | |
| | the schedule | | schedule has been | | | | |
| | | | negative than rating | | | | |
| | | | is 50 if neutral than | | | | |
| | | | rating is 30 else 0 | | | | |
| averageAgentOc- | Average Agent | Agent | If average agent | 81% | 50 | 2 | 100 |
| cupancyAboveThresh- | occupancy | Quotient | occupancy rate is | | | | |
| old | rate above | | above threshold | | | | |
| | Threshold | | rating is 50 | | | | |
| | | | Threshold is 80% | | | | |
| averageAgentOc- | Average Agent | Agent | If average agent | 10% | 20 | 1 | 20 |
| cupancyRate- | occupancy rate | Quotient | occupancy rate | | | | |
| BelowThreshold | below Threshold | | is below | | | | |
| | This indicates | | threshold rating | | | | |
| | than agent are | | is 20 is 80% | | | | |
| | less occupied | | Threshold is | | | | |
| | leading to high | | 50% | | | | |
| | resource cost | | | | | | |
| averageAgentAb- | Average Agent | Agent | If average agent | 11 | 50 | 1 | 50 |
| senteeismRate | Absenteeism rate | Quotient | absenteeism rate | | | | |
| | for given period | | is above 10% than | | | | |
| | | | rating is 50 | | | | |
| | | | If average agent | | | | |
| | | | absenteeism rate | | | | |
| | | | is above 5% and | | | | |
| | | | less than 10% | | | | |
| | | | than rating is 30 | | | | |
| | | | If average agent | | | | |
| | | | absenteeism rate | | | | |
| | | | is above 0% and | | | | |
| | | | less than 5% | | | | |
| | | | than rating is 20 | | | | |
| averageAgentProficiency | Average Agent | Agent | If Average Agent | 8 | 50 | 1 | 50 |
| | Proficiency. | Quotient | proficiency is greater | | | | |
| | Agent proficiency | | than X (e.g., 7) then | | | | |
| | (1-20) with 1 | | rating is 50 | | | | |
| | being highest | | If Average Agent | | | | |
| | proficiency agent | | proficiency is greater | | | | |
| | | | than y (e.g., 3) but less | | | | |
| | | | than X then rating is 30 | | | | |
| | | | If Average Agent | | | | |
| | | | proficiency is greater | | | | |
| | | | than 1 but less than y | | | | |
| | | | then rating is 10 | | | | |
| averageAgentsPer- | Average Count of | Agent | If Average Count of | 6 | 30 | 1 | 30 |
| formingOverTime | Agents performing | Quotient | agents doing overtime | | | | |
| | overtime for a given | | is above threshold | | | | |
| | period for the schedule | | (e.g., 5) than rating | | | | |
| | per day. = Count | | is 30 | | | | |
| | of Agent performing | | | | | | |
| | overtime per day in | | | | | | |
| | the schedule/(Total | | | | | | |
| | number of days) | | | | | | |
| agentsFrom | Agent belongs to | Agent | If x% and above agents | 60 | 50 | 1 | 50 |
| NonPreferredBU | non preferred Business | Quotient | are not from preferred | | | | |
| | Unit (BU). The preferred | | BU list it could impact | | | | |
| | BU list is prepared | | on the schedule as agents | | | | |
| | based on various aspects | | will not be able to perform | | | | |
| | like geographical location, | | as expected. | | | | |
| | skillset, language | | x is configurable and 50 | | | | |
| | preference etc. | | can be considered as default | | | | |
| | | | which indicates half of | | | | |
| | | | the agents are not from | | | | |
| | | | preferred BU | | | | |
| agentPer- | If the schedule has | Agent | Assuming tenure | 8 | 50 | 1 | 50 |
| centHaving- | a majority of new | Quotient | requirement is 6 months. | | | | |
| LessTenure | employees, then there is a | | agentPercentHavingLessTenure | | | | |
| | risk to successfully | | is 5% or above | | | | |
| | meeting the workload and | | then rating is 50. | | | | |
| | SLAs due to inefficiencies | | | | | | |
| | of new employees. If | | | | | | |
| | more than x % of agents | | | | | | |
| | have tenure is less than | | | | | | |
| | y months then schedule | | | | | | |
| | has lot of new agents | | | | | | |
| | that could impact schedule. | | | | | | |
| | agentPercent | | | | | | |
| | HavingLessTenure = | | | | | | |
| | percent of agents having | | | | | | |
| | less than y months of | | | | | | |
| | Tenure | | | | | | |
| agentWith | Agents with many Skills | Agent | Assuming x = 2. | 60% | 50 | 1 | 50 |
| MultiSkill- | assigned are harder to | Quotient | E.g., if percent | | | | |
| Profiles | predict the skill usage | | of agents having | | | | |
| | percentage. If one Skill | | more than 2 skills | | | | |
| | has higher than expected | | is more than threshold | | | | |
| | demand, all other Skills | | (e.g., 50%) then | | | | |
| | will suffer. | | rating is 50 else 0. | | | | |
| | agentWithMulti- | | | | | | |
| | SkillProfiles = | | | | | | |
| | percentage of agents | | | | | | |
| | having more than x skills | | | | | | |
| agentsWith | Percentage of agents that | Agent | Assuming x = 2 | 50% | 50 | 1 | 50 |
| Recently- | have skills assigned for | Quotient | months, if % of agents | | | | |
| AssignedSkills | less than x days. This | | have skills assigned | | | | |
| | indicates that there are | | for less than 2 months | | | | |
| | agents having new skills | | is above threshold than | | | | |
| | which could impact the | | rating is 50 else 0. | | | | |
| | schedule performance | | E.g., threshold is 40 | | | | |
| agentsWorking- | Percentage of employees | Agent | E.g., x = 9, if | 15% | 50 | 1 | 50 |
| LongHours | working in shifts > x | Quotient | e.g., 10% or | | | | |
| | hours (long shifts tend | | greater | | | | |
| | to reduce performance | | percentage of | | | | |
| | as the employee fatigues) | | employees work | | | | |
| | | | for more than 9 | | | | |
| | | | hrs then rating is | | | | |
| | | | 50 else 0 | | | | |
| agentsWith- | Percentage of employees | Agent | E.g., x = 20, if | 15% | 50 | 1 | 50 |
| LessTimeOffs | whose lastday off was x | Quotient | e.g., 10% or greater | | | | |
| | days prior (the efficiency | | percentage of employees | | | | |
| | of employees at the end | | last day off was 20 | | | | |
| | of a series of work days | | days prior then rating | | | | |
| | tends to reduce as the | | is 50 else 0 | | | | |
| | employee fatigues) | | | | | | |
| agentsWith | Percentage of employees | Agent | If 10% of employees did | 11% | 50 | 1 | 50 |
| UnPreferred | who did not receive | Quotient | not receive their | | | | |
| Schedules | their preferred schedule | | preferred schedule than | | | | |
| | for the day (may translate | | rating is 50 | | | | |
| | into poor adherence or | | | | | | |
| | absenteeism or poor | | | | | | |
| | performance) | | | | | | |
| agentsWith | Percentage of agents that | Agent | Assuming x = 3, | 11% | 50 | 1 | 50 |
| Concurrent | handle concurrent skills | Quotient | if 10% or more | | | | |
| SkillsHandling | are harder to predict the | | of agents handle | | | | |
| | skill usage percentage. If | | 3 concurrent | | | | |
| | one Skill has higher than | | skills and if one | | | | |
| | employees with high | | skill has higher | | | | |
| | concurrency may be redirected | | expected | | | | |
| | elsewhere if unexpected | | demand then | | | | |
| | demand shifts occur. | | agent might be | | | | |
| | agentsWithCon- | | redirected to | | | | |
| | currentSkillsHan- | | handle that skill | | | | |
| | dling = | | | | | | |
| | percentage of agents | | | | | | |
| | handling more than x | | | | | | |
| | concurrent skills | | | | | | |

According to some embodiments of the present disclosure, a recommendation module, such as recommendation engine 135a may be operated for auto-corrective measures in one or more systems based on the derived schedule-impact score.

According to some embodiments of the present disclosure, the optimizing of schedules in the WFM system in an order that is based on each schedule schedule-impact score may further include optimizing schedules for resource overstaffing and optimizing for schedules for resource understaffing.

According to some embodiments of the present disclosure, the derived schedule-impact score may be further used for performance rewards and recognition of highly performant agents in schedules having a schedule-impact score above a preconfigured threshold.

According to some embodiments of the present disclosure, the schedule-impact score may be further used by a Quality Management (QM) system by: (i) checking a schedule-impact score above a preconfigured threshold for an increased sampling rate of interactions during the schedule-impact score related schedule; (ii) upon evaluation, assigning agents in interactions lacking quality metrics in the related schedule to training.

FIG. 1B schematically illustrates a high-level diagram of a computerized-system 100B for identifying high impacted schedules, in a contact center, in accordance with some embodiments of the present invention.

According to some embodiments of the present disclosure, computerized-system 100B may include all the components of computerized-system 100A in FIG. 1A.

According to some embodiments of the present disclosure, the schedule quotient module 125b may derive the schedule-quotient score based on retrieved schedule metrics from a database, such as schedule metrics database 115b.

According to some embodiments of the present disclosure, the agent quotient module 120b may derive the agent-quotient score based on retrieved agent metrics from an agent metrics database 105b.

According to some embodiments of the present disclosure, the auto-corrective measures may include at least one of: (i) displaying the derived schedule-impact score of each schedule on schedule management dashboard, such as supervisor dashboard 140a which is associated to a schedule management module in the WFM system; (ii) reporting 140b by generating a report including key statistics representing an impact of the schedule on schedule working days; (iii) performing realignment of routing of an Automatic Call Distribution (ACD) system 140d; and (iv) optimizing schedules in the WFM system 140c in an order that is based on each schedule schedule-impact score.

According to some embodiments of the present disclosure, supervisor dashboard 140a may be for example, a dashboard such as supervisor dashboard 300 in FIG. 300.

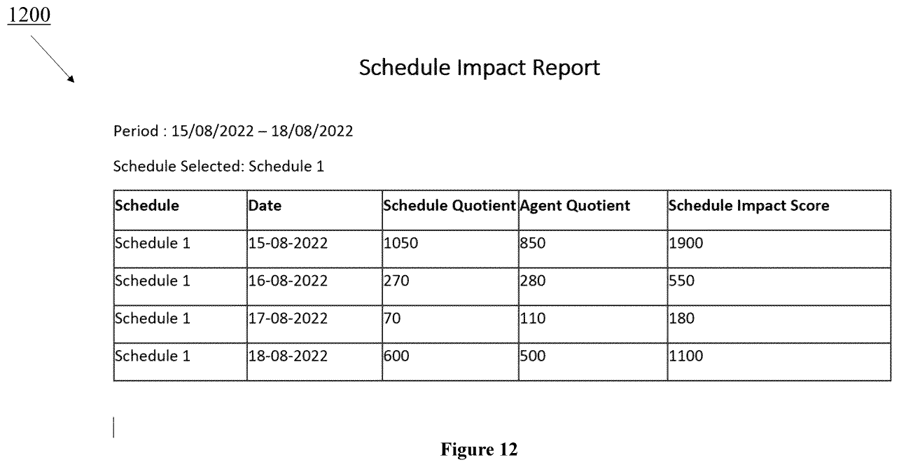

According to some embodiments of the present disclosure, and example for the report including key statistics representing an impact of the schedule on schedule working days is shown in FIG. 12.

According to some embodiments of the present disclosure, the performing of realignment of routing of an Automatic Call Distribution (ACD) system 140d occurs when agents are added or removed from schedules due to a related schedule impact score. As a result, the ACD skill-based routing changes as per added or removed agents list. In skill based routing the calls are routed based on availability and ascending order of skill proficiency where skill proficiency ranges, e.g., from 1 to 20. 1 being the highest proficient agent in that skill and 20 being the lowest proficient agent for that skill

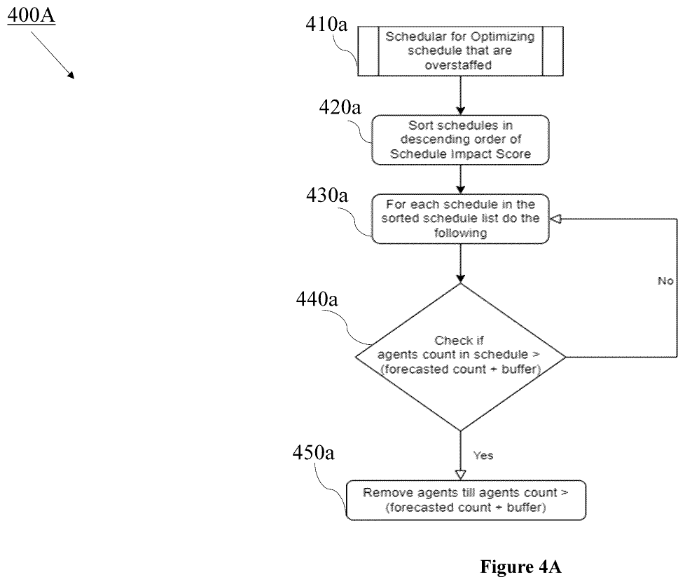

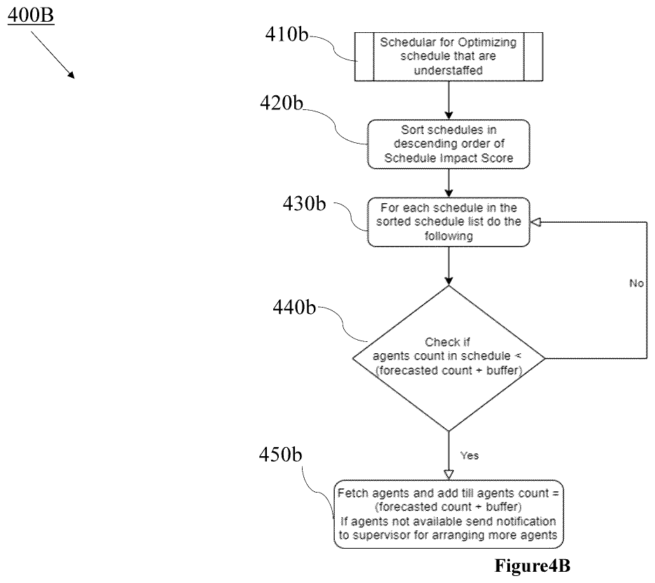

According to some embodiments of the present disclosure, the optimizing of schedules in the WFM system 140c in an order that is based on each schedule schedule-impact score, is shown in detail in FIGS. 4A-4B.

FIG. 2 is a schematic flowchart 200 of an operation of identifying high impacted schedules, in a contact center, in accordance with some embodiments of the present invention.

According to some embodiments of the present disclosure, operation 210 comprising operating a schedule quotient module to derive schedule-quotient score.

According to some embodiments of the present disclosure, operation 220 comprising operating an agent quotient module to derive agent-quotient score.

According to some embodiments of the present disclosure, operation 230 comprising operating a Schedule Impact Score (SIS) module to derive a schedule-impact score based on the derived schedule-quotient score and the derived agent-quotient score.

According to some embodiments of the present disclosure, operation 240 comprising operating a recommendation module for auto-corrective measures in one or more systems based on the derived schedule-impact score.

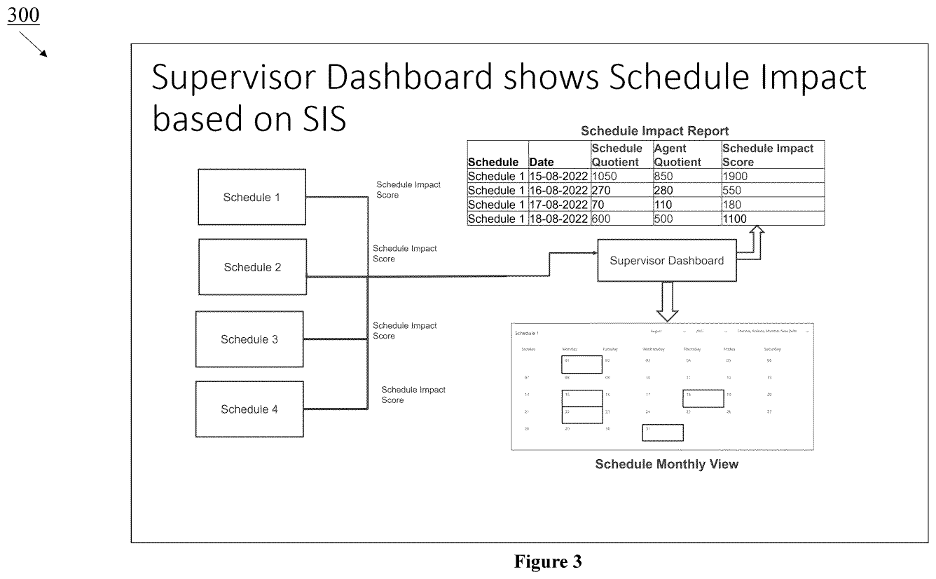

FIG. 3 is an example 300 of schedule impact presented on supervisor dashboard, based on Schedule Impact Score (SIS), in accordance with some embodiments of the present invention.

According to some embodiments of the present disclosure, the displaying of the derived schedule-impact score of each schedule on a schedule management dashboard, such as supervisor dashboard 140a in FIG. 1 which may be associated to a schedule management module in the WFM system, may include for example, schedule name, e.g., ‘schedule 1’, ‘schedule 2’, schedule 3′ and the like, date of the schedule, schedule quotient score, agent quotient score and the derived schedule-impact score that may be shown to a user, such as supervisor for instant visibility and for later on corrective measures.

According to some embodiments of the present disclosure, the schedule-impact score may be further leveraged by the EFM system to fix the impacted schedule, as described in detail in FIGS. 4A-4B.

FIG. 4A is a schematic flowchart 400A of optimizing schedules for resource overstaffing, in accordance with some embodiments of the present invention.

According to some embodiments of the present disclosure, a Workforce Management (WFM) system may operate an optimization of schedules to handle overstaffing in an order that is based on each schedule schedule-impact score. For example, the optimization may be prioritized as per descending order of schedule-impact score such that schedules that are impacted more, e.g., higher schedule-impact score may get optimized earlier as compared to schedules with less impact, e.g., lower schedule-impact score.

According to some embodiments of the present disclosure, optionally, the schedules that are marked for overstaffing may be optimized first, e.g., as shown by workflow 400A and then the schedules that are marked for understaffing may be optimized, e.g., as shown by workflow 400B.

According to some embodiments of the present disclosure, schedular for optimizing schedules that are overstaffed 410a. Then, sort schedules in descending order or schedule impact score 420a. For each schedule in the sorted schedule list do the following 430a: check if agents count in schedule>(forecast count+buffer) 440a, i.e., if the number of agents which are assigned to the schedule is higher than the sum of forecasted number of agents and a preconfigured buffer.

According to some embodiments of the present disclosure, then, remove agents till agents count>(forecast count+buffer) 450a, i.e., remove agents from schedules where the number of agents is higher than the sum of the forecasted number of agents and the preconfigured buffer.

According to some embodiments of the present disclosure, the removal of agents may be implemented in various ways. For example, agents may be removed based on their skill proficiency where agents having the lowest proficiency, i.e., less proficient agents. may be removed. In another example, agents may also be removed based on their schedule adherence, the ones that have good schedule adherence over a period of time may be retained and the ones that have low schedule adherence may be removed from the schedule.

FIG. 4B is a schematic flowchart 400B of optimizing schedules for resource understaffing, in accordance with some embodiments of the present invention.

According to some embodiments of the present disclosure, a Workforce Management (WFM) system may operate an optimization of schedules to handle understaffing in an order that is based on each schedule schedule-impact score. Schedular for optimizing schedule that are understaffed 410b, then sort schedules in descending order or schedule impact score 420b. For each schedule in the sorted schedule list do the following 430b: check if agents count in schedule<(forecast count+buffer) 440b, i.e., if the number of agents which are assigned to the schedule is lower than the sum of forecasted number of agents and a preconfigured buffer.

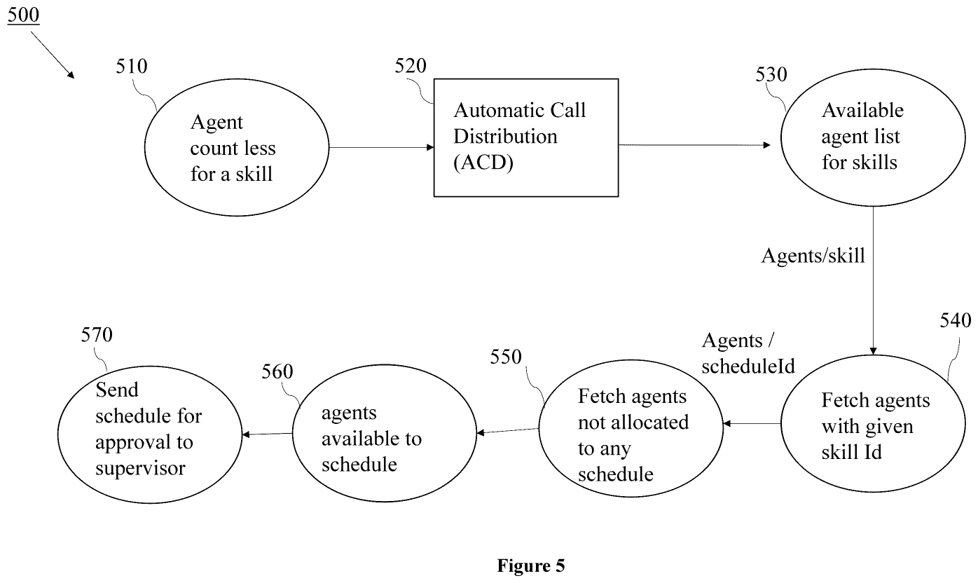

According to some embodiments of the present disclosure, fetch agents and add till agent count=(forecast count+buffer), i.e., fetch agents the number of agents which are assigned to the schedule is equal to the sum of forecasted number of agents and a preconfigured buffer. The agents may be fetched for example, as shown in FIG. 5.

According to some embodiments of the present disclosure, if agents are not available, i.e., when trying to fetch agents, send a notification to a supervisor for arranging more agents 450b. The notification for arranging more agents may be sent to any user.

FIG. 5 is a schematic flowchart 500 of getting the agents from WFM for scheduling, in accordance with some embodiments of the present invention.

According to some embodiments of the present disclosure, when optimizing schedules for resource understaffing in WFM system, when agents count is less for a skill 510 then, WFM system may be configured to allocate agents by generating an agent list for the skills. The agent list for the skill may be generated by fetching agents list that are not allocated to any schedule from the WFM system.

According to some embodiments of the present disclosure, the WFM system may be configured to fetch available agents list for a given skill 530, from a database associated to the WFM system. The agents skill allocation may be stored in a database such as agent-skills datastore which is maintained by the WFM system. An API may be operated to fetch agents having the given skill Id 540.

According to some embodiments of the present disclosure, then, fetch agents not allocated to any schedule 550 by agent schedule mapping which may be maintained in the WFM system and using the API to fetch agents not allocated to any schedule, i.e., agents available to schedule 560.

According to some embodiments of the present disclosure, once the list of agents having a given skill and not allocated to any schedule is available, adding the available agents to the schedule and then optionally, sending the schedule for approval to the supervisor 570 or to any other user.

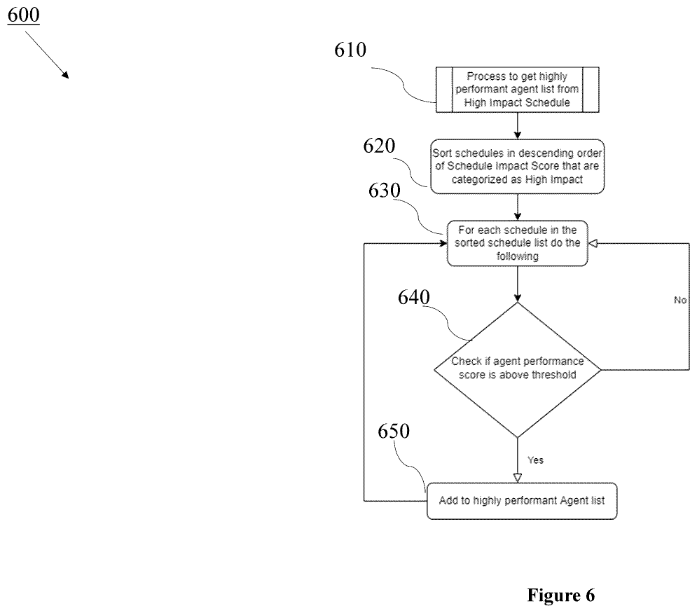

FIG. 6 is a schematic flowchart 600 of performance rewards and recognition for highly performant agents in highly impacted schedule, in accordance with some embodiments of the present invention.

According to some embodiments of the present disclosure, the contact center may have performance reward and recognition for agent performing good in highly impacted schedule to motivate them as well as other agents to perform better. The agent performance score threshold may be defined and updated by the contact center periodically.

According to some embodiments of the present disclosure, initiating a process to get highly performant agent list from high Impact schedule 610. Then, sort schedules in descending order of Schedule Impact Score (SIS) 620.

According to some embodiments of the present disclosure, for each schedule in the sorted schedule list do the following 630: check if agent performance score is above a threshold 640 and if the agent performance score is above the threshold add the agent to highly performant agent list

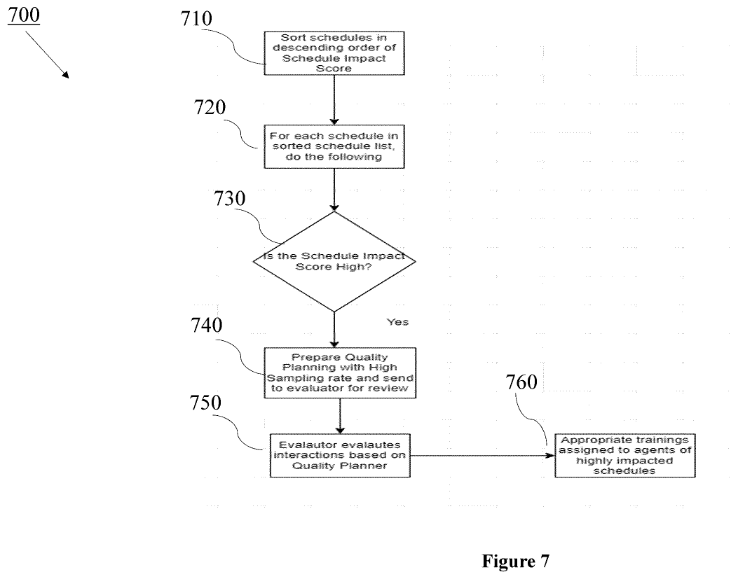

FIG. 7 is a schematic flowchart 700 of schedule-impact score usage by a Quality Management (QM) system, in accordance with some embodiments of the present invention.

According to some embodiments of the present disclosure, since a quality planner, such as Quality Management (QM) system enables to create and manage quality plans from a centralized location and samples random interactions based on defined filters and then the interactions are sent to evaluators for review.

According to some embodiments of the present disclosure, for high impacting schedule the QM system may implement a high sampling rate, i.e., number of interactions to be evaluated per agent. A high impacted schedule may have more sampled data for a better agent evaluation and to ensure that agents which are or have been worked in a high impacted schedule may receive suitable training programs and proactive automated training assignments to critical agents.

According to some embodiments of the present disclosure, for medium to low impacted schedules, i.e., schedules having a schedule-impact score in a preconfigured range, the QM system may implement a lower sampling rate for interaction. Once the interactions are filtered by the QM system based on filters such as call length, interaction type, e.g., with screen, without screen, all, channel type, direction, e.g., incoming, outcoming, internal, Customer Satisfaction Score (CSAT), customer sentiment, agent behavior, e.g., schedule adherence, agent sentiments, agent performance, e.g., ASA, meets SLA, multi-skill efficiency, concurrent interaction efficiency, occupancy rate, overtime are sent for review to evaluators, and accordingly appropriate training programs may be assigned to agents.

According to some embodiments of the present disclosure, sort schedule in descending order of Schedule Impact Score (SIS) 710 and then for each schedule in sorted schedule list do the following 720, check is schedule impact score high 730.

According to some embodiments of the present disclosure, prepare quality planning with high sampling and send to evaluator for review 740 in the QM system.

According to some embodiments of the present disclosure, evaluator evaluates interactions based on quality planner 750 in the QM system, and an appropriate training assigned to agents of highly impacted schedules 760.

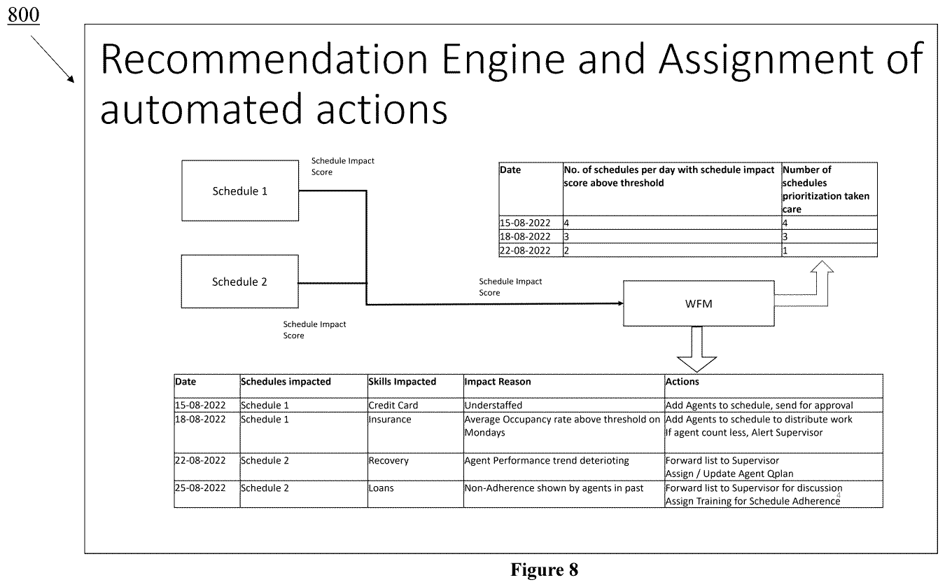

FIG. 8 is an example 800 of a recommendation engine and assignment of automated actions, in accordance with some embodiments of the present invention;

According to some embodiments of the present disclosure, key inputs may be provided as regards ‘Number of schedules per day with schedule impact score above threshold and number of schedules prioritization to take care’ is provided. For example, in case of WFM since its understaffed on 15 Aug. 2020, the WFM action of ‘Get Agents for scheduling for impacted skills’ is taken, as shown in FIG. 4B. Similarly various automated actions may be performance based on schedule impact score and the impacted parameter to help reducing the impact on the schedule.

According to some embodiments of the present disclosure, each contact center may define several manual or automated actions to reduce the impact based on schedule impact score.

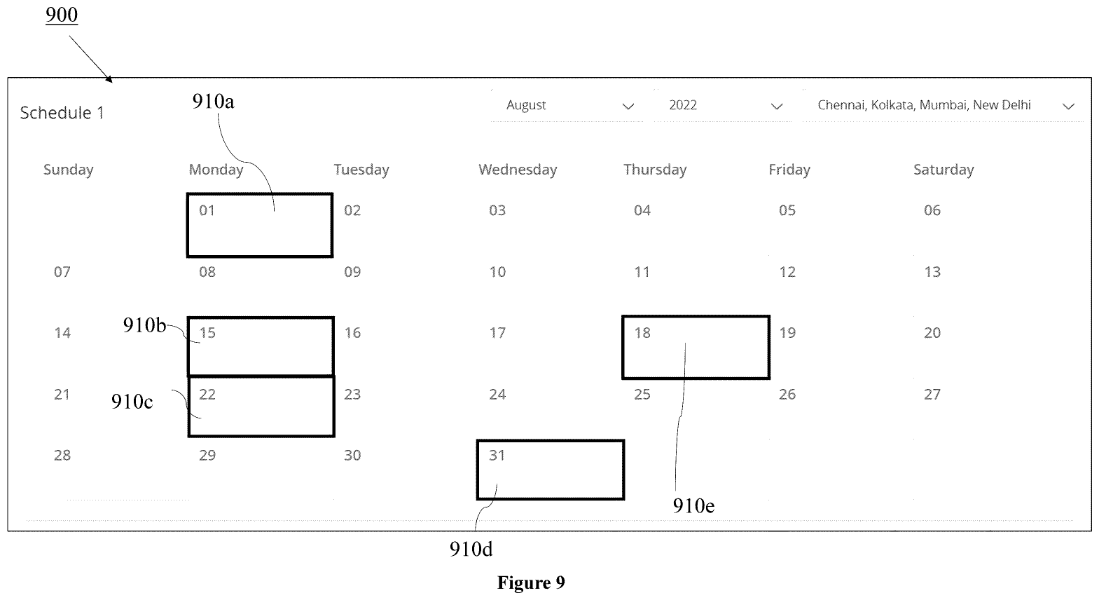

FIG. 9 is an example 900 of a monthly view of a schedule which displays the days on which the schedule is impacted, in accordance with some embodiments of the present invention.

According to some embodiments of the present disclosure, example 900 shows a monthly view of a schedule which displays the days on which ‘Schedule 1’ is impacted. A contact center may define a range to indicate high, medium and low impact schedules. For example, highly impacted schedules which require mitigation, such as 910a-910e. As the impacting parameters are addressed, the schedule-impact score may be reduced, and the schedule may be shown in a different color or any other indication of medium risk. On further mitigation of schedule impacting parameters the schedule can achieve a low impact score indicated by a different color or any other indicator.

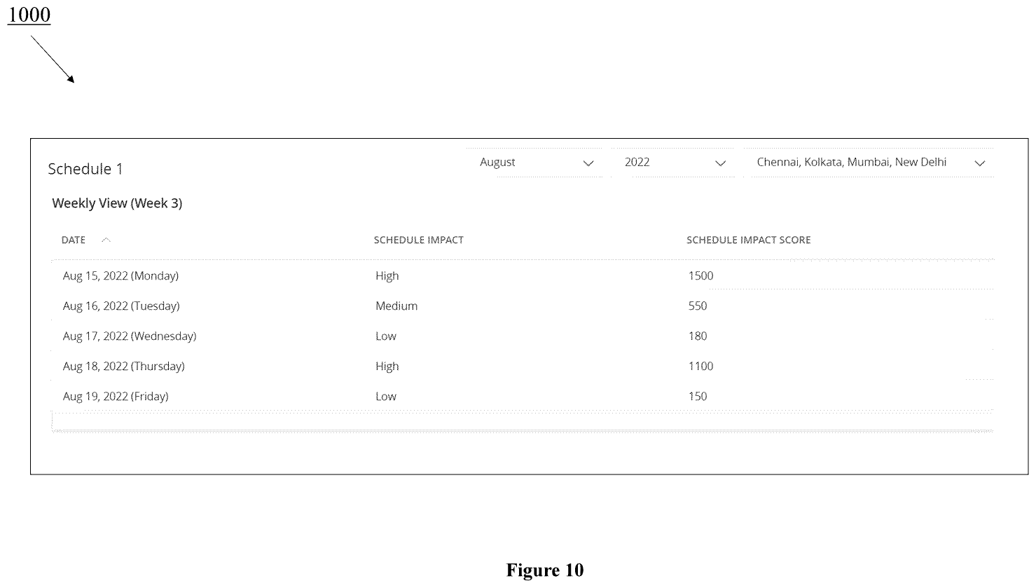

FIG. 10 is an example 1000 of the schedule in weekly view, which can help planning for a week in accordance with some embodiments of the present invention.

According to some embodiments of the present disclosure, in a weekly view a schedule may be displayed such that every day in the week may have a schedule-impact score.

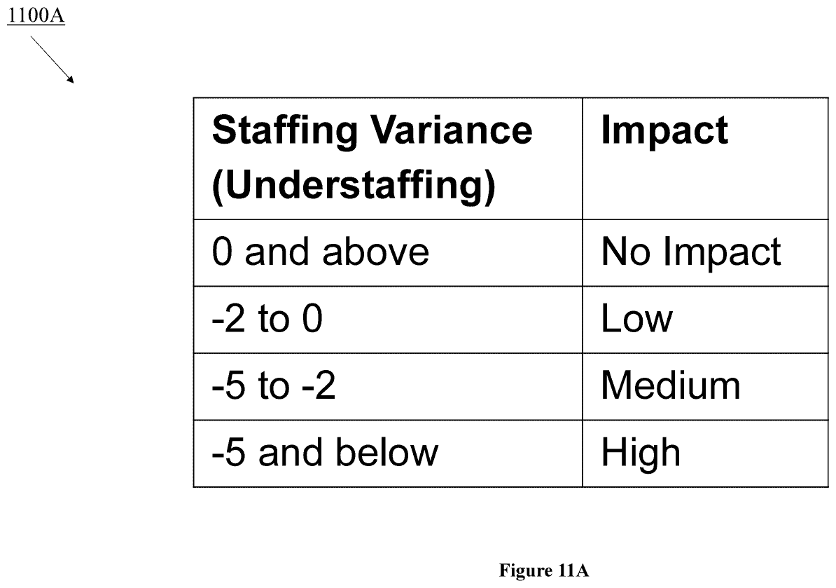

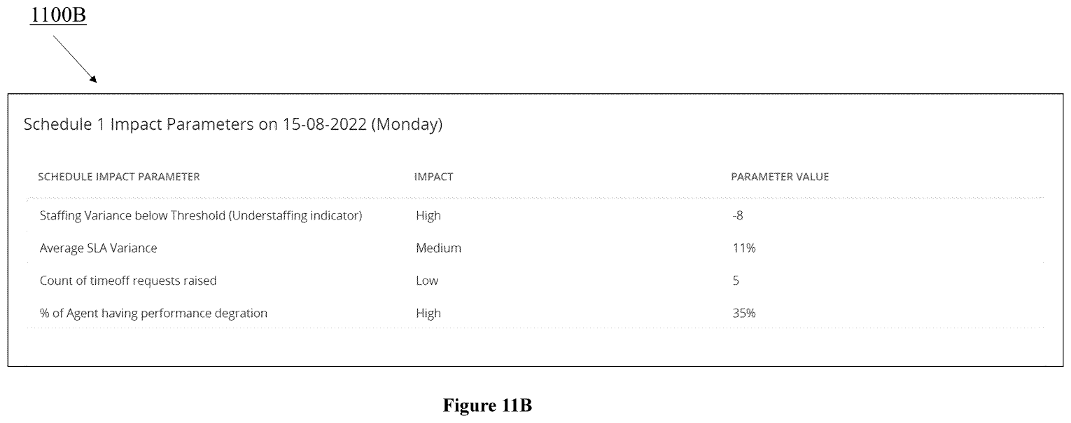

FIGS. 11A-11B show an example of the impacted parameters in a schedule, in accordance with some embodiments of the present invention.

According to some embodiments of the present disclosure, for example, as shown in example 1100A, staffing variance may be configured as ‘high’ when its value is −5 and below. In example 1100B the staffing variance is less than the threshold and equals −8 and therefore may be considered as high impact.

It should be understood with respect to any flowchart referenced herein that the division of the illustrated method into discrete operations represented by blocks of the flowchart has been selected for convenience and clarity only. Alternative division of the illustrated method into discrete operations is possible with equivalent results. Such alternative division of the illustrated method into discrete operations should be understood as representing other embodiments of the illustrated method.

Similarly, it should be understood that, unless indicated otherwise, the illustrated order of execution of the operations represented by blocks of any flowchart referenced herein has been selected for convenience and clarity only. Operations of the illustrated method may be executed in an alternative order, or concurrently, with equivalent results. Such reordering of operations of the illustrated method should be understood as representing other embodiments of the illustrated method.

Different embodiments are disclosed herein. Features of certain embodiments may be combined with features of other embodiments; thus, certain embodiments may be combinations of features of multiple embodiments. The foregoing description of the embodiments of the disclosure has been presented for the purposes of illustration and description. It is not intended to be exhaustive or to limit the disclosure to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the disclosure.

While certain features of the disclosure have been illustrated and described herein, many modifications, substitutions, changes, and equivalents will now occur to those of ordinary skill in the art. It is, therefore, to be understood that the appended claims are intended to cover all such modifications and changes as fall within the true spirit of the disclosure.

What is claimed:

1. A computerized-method for identifying high impacted schedules, in a contact center, said computerized-method comprising:
retrieving schedules of agents during a preconfigured period from a Workforce Management (WFM) system, for each schedule:
(i) operating a schedule quotient module to derive schedule-quotient score;
(ii) operating an agent quotient module to derive agent-quotient score;
(iii) operating a Schedule Impact Score (SIS) module to derive a schedule-impact score based on the derived schedule-quotient score and the derived agent-quotient score; and
(iv) operating a recommendation module for auto-corrective measures in one or more systems based on the derived schedule-impact score.

2. The computerized-method of claim 1, wherein the retrieved schedules are at least one of: (i) active schedules and the schedule-impact score is derived in real-time; and (ii) future schedules.

3. The computerized-method of claim 1, wherein the auto-corrective measures include at least one of: (i) displaying the derived schedule-impact score of each schedule on schedule management dashboard which is associated to a schedule management module in the WFM system; (ii) generating a report including key statistics representing an impact of the schedule on schedule working days; (iii) performing realignment of routing of an Automatic Call Distribution (ACD) system; (iv) optimizing schedules in the WFM system in an order that is based on each schedule schedule-impact score.

4. The computerized-method of claim 1, wherein the schedule quotient module derives the schedule-quotient score based on retrieved schedule metrics from a schedule metrics database.

5. The computerized-method of claim 1, wherein the agent-quotient score is derived based on retrieved agent metrics from an agent metrics database.

6. The computerized-method of claim 1, wherein the schedule quotient module derives the schedule-quotient score based on at least one parameter of:
(i) schedule staffing variance;
(ii) Schedule average Service Level Agreement (SLA) variance in a preconfigured period;
(iii) Average Handle Time (AHT) for this schedule in the preconfigured period;
(iv) Average Speed of Answer (ASA) for the schedule in the preconfigured period;
(v) number of time-off requests raised for the schedule in status of approved, pending and denied;
(vi) number of shift trade-off requests raised for the schedule in status of approved, pending and denied;
(vii) forecast results of whether the schedule could be impacted due to natural calamities or pandemic situations;
(viii) forecast results for trend change in call or interactions volume for this schedule;
(ix) average customer sentiment for interactions handled in the schedule in the preconfigured period;
(x) number of schedule changes in status of approved, pending and denied; and
(xi) percentage of agents having a user-defined activity code which prevents them from contributing to participate in activities of the schedule.

7. The computerized-method of claim 1, wherein the agent quotient module derives the agent-quotient score based on at least one parameter of:
(i) average schedule adherence;
(ii) average agent performance;
(iii) average agent proficiency;
(iv) average agent sentiments for interactions handled in the schedule in a preconfigured period;
(v) average agent occupancy rate in the schedule in the preconfigured period;
(vi) agent absenteeism trend in the preconfigured period;
(vii) agent performing overtime;
(viii) agent tenure;
(ix) agent with more than a preconfigured number of skills;
(x) percentage of agents with assigned skills in less than preconfigured number of days;
(xi) percentage of agents handling concurrent interactions in a preconfigured number of skills;
(xii) percentage of agents working shifts more than a preconfigured number of hours;
(xiii) percentage of agents whose last day off was a preconfigured number of days prior to the schedule;
(xiv) agents schedule preferences;
(xv) agent handling more than a preconfigured number of concurrent interactions;
(xvi) percentage of agents not associated to a preconfigured business unit; and
(xvii) total time planned for a user-defined activity code where the agent would not contribute to the schedule with the agent's skills.

8. The computerized-method of claim 3, wherein the optimizing of schedules in a Workforce Management (WFM) system in an order that is based on each schedule schedule-impact score comprising optimizing schedules for resource overstaffing and optimizing for schedules for resource understaffing.

9. The computerized-method of claim 1, wherein the derived schedule-impact score is further used for performance rewards and recognition of highly performant agents in schedules having a schedule-impact score above a preconfigured threshold.

10. The computerized-method of claim 1, wherein the schedule-impact score is further used by a Quality Management (QM) system by: (i) checking a schedule-impact score above a preconfigured threshold for an increased sampling rate of interactions during the schedule-impact score related schedule; (ii) upon evaluation, assigning agents in interactions lacking quality metrics in the related schedule to training.

11. The computerized-method of claim 1, wherein the SIS module derives the schedule-impact score base on formula I:
Schedule Impact Score=Σ(schedule-quotient score×W₁+agent-quotient score×W₂) (II)
whereby:
schedule-quotient score is the derived schedule-quotient score,
agent-quotient score is the derived agent-quotient score,
W₁ is a first preconfigured weightage,
W₂ is a second preconfigured weightage,
wherein a value of W₁ and a value of W₂ ranges between ‘0’ and ‘1’.

12. A Computerized-system for identifying high impacted schedules, in a contact center, said computerized-system comprising:
one or more processors;
database of agent metrics;
database of schedule metrics;
a memory to store the database of agents metrics and the database of schedule metrics,
said one or more processors are configured to retrieve schedules during a preconfigured period from a WFM system, for each schedule:
(i) operating a schedule quotient module to derive schedule-quotient score based on schedule metrics retrieved from the database of schedule metrics;
(ii) operating an agent quotient module to derive agent-quotient score based on agent metrics retrieved from the database of agent metrics;
(iii) operating a Schedule Impact Score (SIS) module to derive a schedule-impact score based on the derived schedule-quotient score and the derived agent-quotient score; and
(iv) operating a recommendation module for auto-corrective measures in one or more systems based on the derived schedule-impact score.
